(19) United States
(12) Patent Application Publication
(10) Pub. No.: US 2023/0117225 A1
(43) Pub. Date: Apr. 20, 2023

(54) AUTOMATED WORKFLOW ANALYSIS AND SOLUTION IMPLEMENTATION

(71) Applicant: INTERNATIONAL BUSINESS MACHINES CORPORATION, Armonk, NY (US)

(72) Inventors: Gustavo Porto Guedes, Louveira (BR); Larissa Lara Machado de Campos, Sao Paulo (BR); Grasiele Domingos, Sao Paulo (BR); Tiago Dias Generoso, Poços de Caldas (BR)

(21) Appl. No.: 17/502,679

(22) Filed: Oct. 15, 2021

(51) Int. Cl. G06Q 10/06; G06N 5/02; G06N 20/00

(52) U.S. Cl. CPC G06Q 10/0633; G06Q 10/06375; G06N 5/022; G06N 20/00

(57) ABSTRACT

Systems and methods enable automated workflow analysis implementations of solutions. In embodiments, a method includes: aggregating input data from an environment from multiple data sources; automatically identifying a problem in a workflow implemented in the environment by processing and analyzing the workflow based on the aggregated input data; automatically determining solutions to the problem in the workflow using at least one iteratively trained machine learning model to analyze the processed input data, including: identifying characteristics of the workflow; identifying one or more candidate solutions based on the characteristics; ranking the one or more candidate solutions; and determining the one or more solutions to the problem based on the ranking; and automatically implementing at least one of the one or more solutions to address the problem in the workflow, thereby creating an updated workflow in the environment.

### BACKGROUND

Aspects of the present invention relate generally to workflow management and, more particularly, to automated workflow analysis and solution implementation.

Businesses often utilize workflows for manual and automated tasks. The term workflow refers to an orchestrated and repeatable pattern of activity, enabled by the systematic organization of resources into processes that transform materials, provide services, or process information. In general, a workflow can be understood as a series of activities that are necessary to complete a task. Categories of workflows include, for example: onboarding workflows, which can be related to several processes (e.g., onboarding new workers, onboarding new clients, adding new servers on a datacenter, etc.); approval workflows, which can be applied to items such as adding extra hardware on a server, buying or renewing software licenses, etc.; and incident workflows, which can relate to how issues are monitored, detected, alerted and handled.

### SUMMARY

In a first aspect of the invention, there is a computer-implemented method including: aggregating, by a computing device, input data from an environment from multiple data sources, thereby generated aggregated input data; automatically identifying, by the computing device, a problem in a workflow implemented in the environment by processing and analyzing the workflow based on the aggregated input data, thereby producing processed input data; and automatically determining, by the computing device, one or more solutions to the problem in the workflow using at least one iteratively trained machine learning model to analyze the processed input data. The analyzing the processed input data includes: identifying characteristics of the workflow; identifying one or more candidate solutions based on the characteristics; ranking the one or more candidate solutions; and determining the one or more solutions to the problem based on the ranking. The method further includes automatically implementing, by the computing device, at least one of the one or more solutions to address the problem in the workflow, thereby creating an updated workflow in the environment.

In another aspect of the invention, there is a computer program product including one or more computer readable storage media having program instructions collectively stored on the one or more computer readable storage media. The program instructions are executable to: automatically identify a problem in an IT workflow implemented in the environment by processing and analyzing the IT workflow based on input data from the environment, thereby producing processed input data, wherein the IT workflow is at least partially automated and includes a series of steps to complete an IT process; automatically determining one or more solutions to the problem in the IT workflow using at least one iteratively trained machine learning model to analyze the processed input data, wherein the analyzing the processed input data includes; identifying characteristics of the IT workflow, including steps of the IT workflow; identifying one or more candidate solutions by correlating steps of the IT workflow with steps of one or more market solutions and steps of one or more solutions in a knowledge base store; ranking the one or more candidate solutions based on business parameters derived from the aggregated input data; and determining the one or more solutions to the problem based on the ranking; and determining whether to automatically implement at least one of the one or more solutions to address the problem in the IT workflow or send a notification to a user regarding the at least one of the one or more solutions based on a complexity of the at least one of the one or more solutions.

In another aspect of the invention, there is system including a processor, a computer readable memory, one or more computer readable storage media, and program instructions collectively stored on the one or more computer readable storage media. The program instructions are executable to: automatically identify a problem in an IT workflow implemented in the environment by processing and analyzing the IT workflow based on input data from the environment, thereby producing processed input data, wherein the IT workflow is at least partially automated and includes a series of steps to complete an IT process; automatically determining one or more solutions to the problem in the IT workflow using at least one iteratively trained machine learning model to analyze the processed input data, wherein the analyzing the processed input data includes; identifying characteristics of the IT workflow, including steps of the IT workflow; identifying one or more candidate solutions by correlating steps of the IT workflow with steps of one or more market solutions and steps of one or more solutions in a knowledge base store, wherein the knowledge base store includes previously implemented IT workflows of the environment; ranking the one or more candidate solutions based on business parameters derived from the aggregated input data; and determining the one or more solutions to the problem based on the ranking; and determining whether to automatically implement at least one of the one or more solutions to address the problem in the IT workflow or send a notification to a user regarding the at least one of the one or more solutions based on a complexity or impact of the at least one of the one or more solutions.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is a diagram illustrating exemplary categories of workflow errors and inefficiencies that may be addressed by embodiments of the invention.

FIG. 5 is a flowchart illustrating an overview of a workflow evaluation process in accordance with embodiments of the invention.

FIG. 6 is a diagram illustrating exemplary inputs and outputs of the method of FIG. 5 in accordance with embodiments of the invention.

FIG. 7 shows a block diagram of an exemplary environment in accordance with embodiments of the invention.

FIG. 8 is a diagram illustrating system components in accordance with embodiments of the invention.

FIG. 9 is a flowchart of an exemplary workflow evaluation method in accordance with embodiments of the invention.

FIG. 10 is a flowchart illustrating steps of a workflow evaluation method in accordance with embodiments of the invention.

FIG. 11 is a diagram illustrating a machine learning pipeline in accordance with embodiments of the invention.

FIG. 12 is a flowchart illustrating an online workflow method in accordance with embodiments of the invention.

FIG. 13 is a flowchart illustrating an offline workflow method in accordance with embodiments of the invention.

### DETAILED DESCRIPTION

Aspects of the present invention relate generally to workflow management and, more particularly, to automated workflow analysis and solution implementation. Embodiments of the invention collect and identify usage of workflows in an environment, generate solutions for better workflows based on environment information, analyze and compare current workflows with available market workflows (e.g., templates), analyze security workflows to identifies security issues (e.g., using synthetic monitoring), initiate automated changes to workflows on run time (e.g., to address bottlenecks in a workflow), and initiate automated changes to workflows to address security issues (e.g., vulnerabilities).

Companies often rely on technology to transform their business processes, culture and customer experience to meet constantly changing needs of the business and market requirements. Companies may utilize multiple kinds of platforms, architectures and multidisciplinary teams to deliver high value solutions, which leads to an increase in the complexity of the companies' information technology (IT) environment. The desire for workflow management increases significantly as a company automates business and IT processes. In general, workflow management allows teams of workers to focus on valuable tasks for the business, while ensuring the tasks follow the appropriate standards, best practices, security requirements, etc. This results in greater agility regarding time to market.

Some workflow management solutions provide default templates that beginner users can utilize. Often such default templates are used without any knowledgeable user evaluating whether the workflow steps of the default templates are the best way to deliver specific requirements. Moreover, if workflow from a default template is working, even it if is not optimal, the workflow may never be reviewed for efficiency/optimization and may lead to the same sub-optimal workflow being utilized, sometimes for years.

Embodiments of the invention provide a technical solution to the technical problem of determining errors and inefficiencies in environments with partially or wholly computer-automated workflows. The term workflow as used herein refers to an orchestrated and repeatable pattern of activity, enabled by the systematic organization of resources into processes that transform materials, provide services, or process information. In implementations, the workflow is an IT workflow that is at least partially automated, and which can be understood as a series of activities or steps that are necessary to complete an IT process. Implementations of the invention provide improved workflow systems and methods enabling automated workflow updates and automated error or inefficiency notifications. Aspects of the invention result in more efficient use of IT resources by automatically implementing solutions to reduce inefficiencies (e.g., bottlenecks) in workflows.

Embodiments of the invention provide a computer-implemented process for workflow automation, including: in response to receiving information from a plurality of sources including predetermined data sources, user interactions and previous workflow executions, aggregating the information received to form aggregated information; analyzing the aggregated information by a data analysis component using a predetermined workflow evaluation process to form analyzed results; and processing the analyzed results by a workflow optimization engine/module component using an iteratively updated predetermined previously trained machine learning model to examine the information received and the analyzed results to detect patterns as candidate solutions for use in decisions affecting workflow capabilities.

In aspects of the invention, the method further includes: in response to detecting the patterns as candidate solutions for use in decisions affecting workflow capabilities, determining whether a solution can be automatically applied; in response to a determination the solution cannot be automatically applied, indicating the solution requires human intervention in a later schedule-to-implement; and in response to applying the solution, updating the knowledge base to include findings (positive and negative), associated with one of a resulting changed workflow and a new workflow.

Embodiments of the invention provide numerous advantages in an IT environment. For example, embodiments of the invention: provide workflow management as a service, which is capable of being integrated with existing solutions that offer the development of workflows, but do not have an artificial intelligence (AI) component to analyze the IT environment and users behavior; are not limited to only standard workflows, and always consider new workflows and templates available on the market based on observed changes within the IT environment; provide automated advice for a better workflow based on the environment data/information and best practices; implement custom features on workflow runtime; perform a security verification process to check threats on active workflows and implement fixes in real time, preventing vulnerabilities from attackers in the workflows process; validate hardware, software and licenses lifecycles, in order to automatically notify users when a new asset should be renewed; reduce the time to implement new workflows or change old workflows, as the solution focuses on delivering the best recommendation based on the business and IT infrastructure; reduce implementation costs, as it maintains old workflows and helps to create new workflows; provide assistance to implement complex workflows based on data collected from a business, in order to provide the best guidance to implement a new component on the IT workflow; and keep workflows accurate as a company incorporates new technologies, based on a knowledge base built on knowledge from multiple environments and technical cases.

It should be understood that, to the extent implementations of the invention collect, store, or employ personal information provided by, or obtained from, individuals (for example, user behavior and pattern data), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

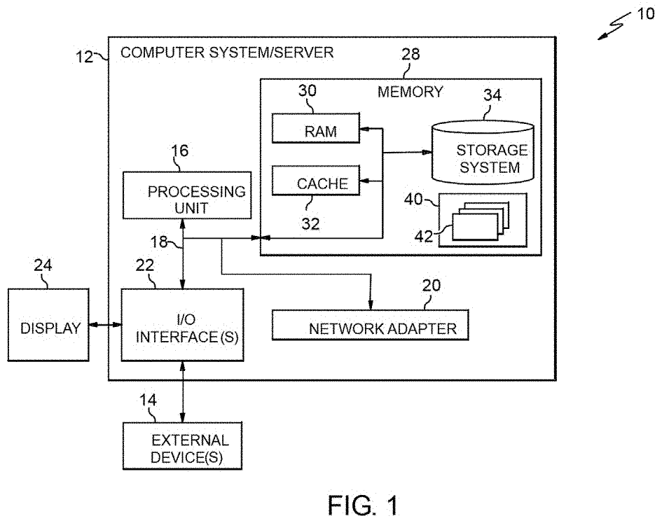

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

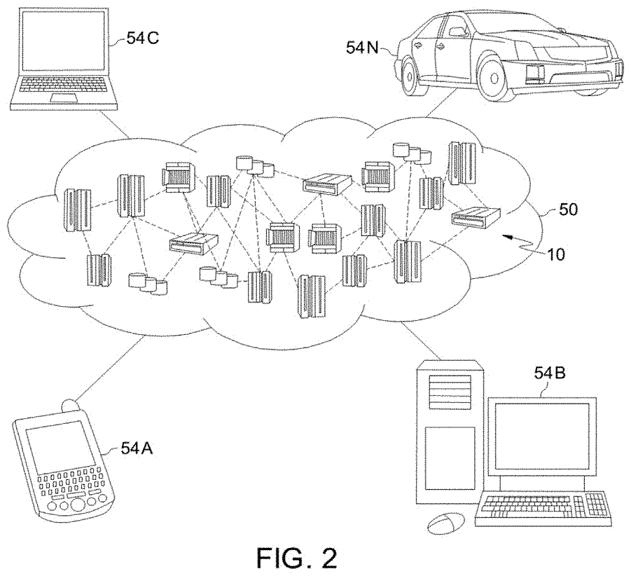

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

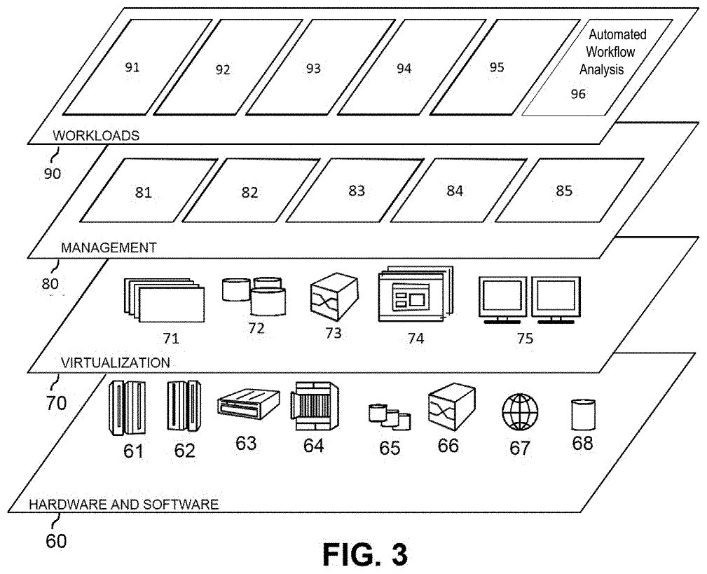

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and automated workflow analysis 96.

Implementations of the invention may include a computer system/server 12 of FIG. 1 in which one or more of the program modules 42 are configured to perform (or cause the computer system/server 12 to perform) one of more functions of the automated workflow analysis 96 of FIG. 3. For example, the one or more of the program modules 42 may be configured to: aggregate input data from an environment from multiple data sources, thereby generated aggregated input data; automatically identify a problem in a workflow implemented in the environment by processing and analyzing the workflow based on the aggregated input data, thereby producing processed input data; automatically determine one or more solutions to the problem in the workflow using at least one iteratively trained machine learning model to analyze the processed input data; and automatically implementing at least one of the one or more solutions to address the problem in the workflow, thereby creating an updated workflow in the environment.

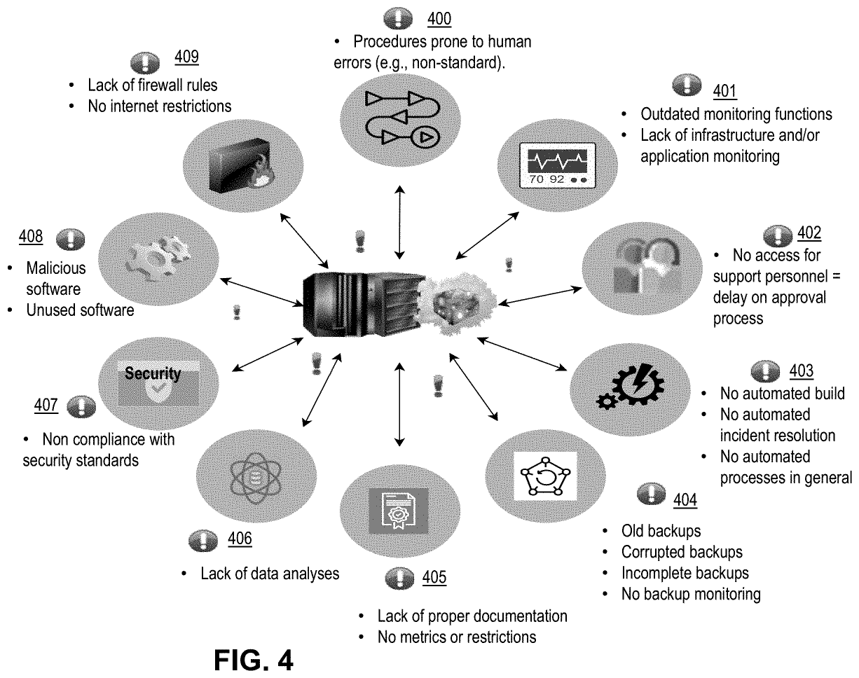

FIG. 4 is a diagram illustrating exemplary categories of workflow errors and inefficiencies that may be addressed by embodiments of the invention. As illustrated in FIG. 4, categories of workflow errors or inefficiencies (problems) addressed by embodiments of the invention may include, for example: procedures prone to human error 400 (e.g., non-standard procedures); automated monitoring errors 401 (e.g., outdated monitoring functions, lack of infrastructure and/or application monitoring); personnel access errors 402 (e.g., no access for support personnel may delay approval processes); automated process inefficiencies 403 (e.g., no automated build, no automated incident resolution, no automated processes in general); data backup issues 404 (e.g., old backups; corrupted backups, incomplete backups, no backup monitoring); certification issues 405 (e.g., lack of proper documentation, no metrics, no restrictions); data analysis issues 406 (e.g., lack of data analysis); security issues 407 (e.g., non-compliance with security standards); software issues 408 (e.g., malicious software, unused software); and network security issues 409 (e.g., lack of firewall rules, no internet restrictions).

Most of the problems identified in FIG. 4 are related to a lack of automated solutions that analyze workflow behavior to improve flow steps and meet the requirements (including new requirements) of a company and its IT infrastructure. Additionally, when security workflows involving software are working, there may be no incentive for a company to review the workflow for problems (e.g., authentication steps), potentially providing possibilities for attackers to use exfiltration to exploit the problems and harming the environment (e.g., IT environment). Implementations of the invention can understand an IT environment and workflow behavior within the environment to continuously improve, or provide advice to improve, workflows used by IT tools, and also to provide automations on the fly during work flow runtime (e.g., automatic access approval based on user behavior, data and flow pattern).

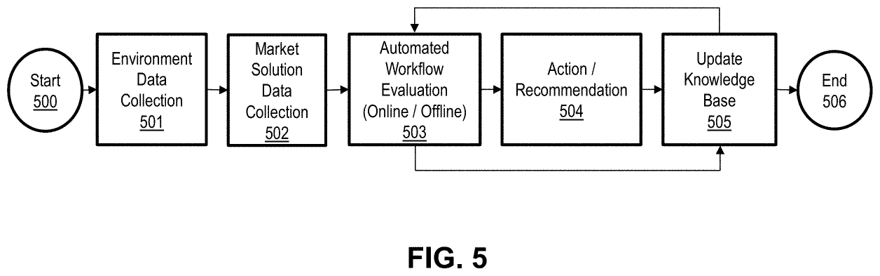

FIG. 5 is a flowchart illustrating an overview of a workflow evaluation process in accordance with embodiments of the invention. In the example of FIG. 5, at 500, the method is initiated (e.g., manually or automatically). At 501, environment data (data inputs) associated with workflow in a business or IT environment at issue (e.g., a company, service provider, etc.) is collected and aggregated. At 502, market solution data is collected, such as predetermined workflow templates and workflow procedures/steps. At 503, an evaluation of an existing workflow (e.g., IT workflow) or group of workflows in the environment at issue is performed (e.g., online in real time and/or offline) to identify one or more potential or actual errors and/or inefficiencies in the workflow(s). At 504, an automated action or recommendation is generated, which addresses or identifies the potential or actual errors and/or inefficiencies in the workflow(s). At 505, a knowledge base is updated. The term knowledge base as used herein refers to a store of structured and/or unstructured information for use in automated workflow evaluation methods according to embodiments of the invention. At 506, the workflow evaluation method ends. Method steps of FIG. 5 may be performed by one or more computing components described below, in accordance with embodiments of the invention.

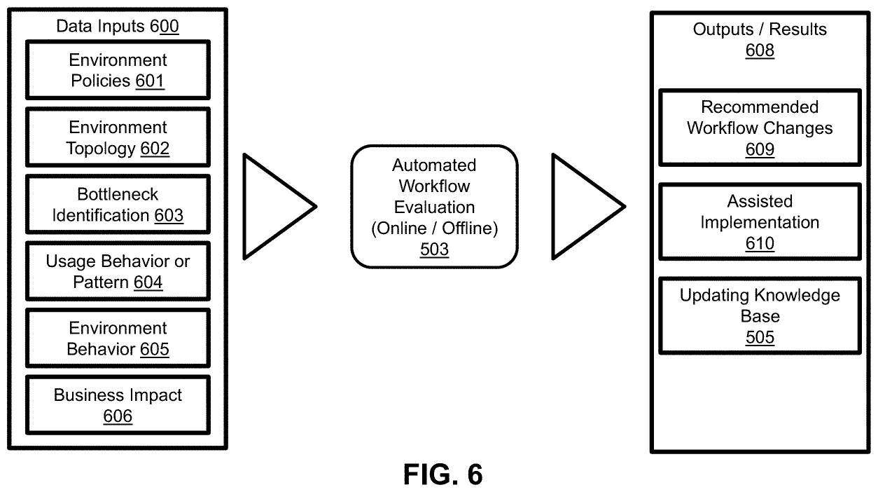

FIG. 6 is a diagram illustrating exemplary inputs and outputs of the method of FIG. 5 in accordance with embodiments of the invention. FIG. 6 shows exemplary data inputs (environment data) that may be collected for an environment at issue (e.g., IT environment of company or service provider), including: environment policies data 601 (e.g., access rules or restrictions, security policies and other procedures specific to the environment at issue); environment topology data 602 (e.g., physical and network topology including hardware, software, computing resources such as bandwidth, network connections, etc.); bottleneck identification data 603 (e.g., a point in a process that is relatively slow compared to other parts of the process or similar processes); usage behavior or pattern data 604 (e.g., how users are utilizing the system and patterns of usage behavior amongst users); environment behavior data 605 (e.g., how the physical and network topology components are utilized, such usage of hardware, software, bandwidth, etc.); and business impact data 606 (e.g., how workflow steps or processes impact or effect business goals, policies and/or rules). In implementations, a system is provided to enable the automated workflow evaluation 503 of the data inputs 600, for the generation of outputs/results 608. In the example of FIG. 6, outputs/results of the automated workflow evaluation 503 include: recommended workflow changes 609; assisted implantations 610 for automated implementation of one or more workflow solutions to address potential or actual errors or inefficiencies; and updates to the knowledge base 505.

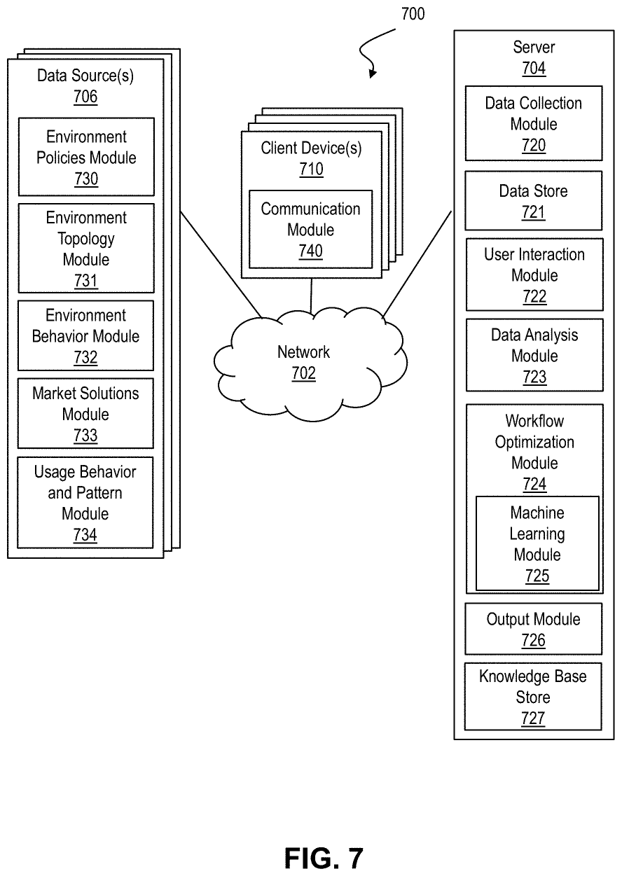

FIG. 7 shows a block diagram of an exemplary environment 700 in accordance with embodiments of the invention. In embodiments, the environment 700 includes a network 702 enabling communication between a server 704, one or more data sources represented at 706, and one or more client devices represented at 710. The server 704, one or more data sources 706 and one or more client device 710 may each comprise the computer system/server 12 of FIG. 1, or elements thereof. The environment 700 may be a cloud computing environment, such as the cloud computing environment 50 of FIG. 2, or a local environment, such as a local network environment of a business.

In implementations, the server 704 is a computing node 10 within the cloud computing environment 50 and provides services to one or more cloud consumers. The one or more data sources 706 may comprise computing device of cloud consumers or computing nodes 10 in the cloud computing environment 50 of FIG. 2. In embodiments, the one or more client devices 710 comprise computing devices used by cloud consumers, such as, for example, the personal digital assistant (PDA) or cellular telephone 54A, the desktop computer 54B, the laptop computer 54C, and/or the automobile computer system 54N depicted in FIG. 2.

In embodiments, the server 704 comprises one or more modules, each of which may comprise one or more program modules such as program modules 42 described with respect to FIG. 1. In the example of FIG. 7, the server 704 includes: a data collection module 720 for collecting and storing data in a data store 721; a user interaction module 722; a data analysis module 723; a workflow optimization module 724, including a machine learning module 725; an output module 726; and a knowledge base store 727 (each of which may comprise program module(s) 42 of FIG. 1).

In implementations, the data collection module 720 is configured to collect data from one or more data sources 706 and/or one or more client device 710, including, for example, policies for an environment at issue, topology data of the environment at issue; environment behavior data (e.g., behavior of physical and network components of the environment at issue); and market solutions data (e.g., available workflow templates, workflow processes, and workflow tools or solutions). In aspects of the invention, the data collection module 720 is responsible for providing the server 704 with the input data required to identify whether a workflow needs improvements, and/or whether any steps of the workflow comprise business results.

In embodiments, the user interaction module 722 is configured to obtain usage data (e.g., real-time or historic data) for users of the environment at issue from the one or more data sources 706 and/or the one or more client devices 710. In aspects of the invention, the user interaction module 722 is responsible for collecting information regarding how users are executing routines or processes, and how the users interact with systems and software (e.g., which commands are manually executed during a change window). In one example, when the environment 700 is an internal network of a business, the user interaction module 722 may collect usage data from individual client devices 710 of personnel. In another example, when the environment 700 is a cloud computing environment and is an authorized provider of services to a business, the user interaction module 722 may collect usage data from a server of the business (e.g., a data source 706) or from individual client devices 710 of the business, via the network 702.

In aspects of the invention, the data analysis module 723 is configured for: gathering input data from previous executions of workflows, usage data, and other sources of data; cleaning and inspecting the input data with the objective of discovering useful information; identifying bottleneck points in workflows; predicting possible flaws in workflow execution; identifying performance issues; predicting necessary interactions among workflow objects or business departments; and generally analyze and process collected input data for input to the workflow optimization module 724.

In implementations, the workflow optimization module 724 includes AI components, and is configured to observe collected data and identify patterns to make better workflow decisions to improve workflow capabilities. In embodiments, the workflow optimization module 724 is configured to determine one or more solutions to identified potential problems or inefficiencies of a workflow, and communicate the solutions to the output module 726. In implementations, the workflow optimization module 724 includes or works with the machine learning module 725, which is configured to generate and train models for use by the workflow optimization module 724 during workflow analysis. One of ordinary skill in the art would understand that various model building and training techniques and methods may be utilized to generate models for use by the server 704.

In embodiments, the output module 726 is configured to initiate automated actions to address the identified potential problems or inefficiencies and/or automatically generate notifications regarding solutions to the potential problems or inefficiencies (e.g., recommendations to a user). In implementations, knowledge gained from the workflow evaluation is used to update the knowledge base store 727.

In embodiments, the one or more data sources 706 each comprise one or more modules, each of which may include one or more program modules such as program modules 42 described with respect to FIG. 1. In the example of FIG. 7, the one or more data sources 706 include: an environment policies module 730; an environment topology module 731; an environment behavior module 732; a market solutions module 733; and a usage behavior and pattern module 734 (each of which may comprise program module(s) 42 of FIG. 1). In implementations, the environment policies module 730 is configured to provide data regarding policies of an entity (e.g., a business) to the server 704; the environment topology module 731 is configured to provide data regarding physical and/or network topologies of an entity to the server 704; and the environment behavior module 732 is configured to provide data regarding the behavior of the physical and/or network topology components (e.g., servers, data stores, etc.) to the server 704.

In aspects of the invention, the market solutions module 733 is configured to provide data regarding existing (market) workflow tools and solutions, such as workflow templates, to the server 704. In implementations, one or more of the data sources 706 comprises a third party source, such as a third party providing workflow tools and solutions (e.g., software tools, workflow templates, etc.).

In embodiments of the invention, the usage behavior and pattern module 734 is configured to provide data regarding user (e.g., personnel) behavior and patterns with respect to workflows of the environment at issue, to the server 704. In embodiments, usage behavior and pattern data may alternatively or additionally be collected by the server 704 directly from one or more client devices 710 (e.g., user computing devices), such as from a communication module 740 of a client device 710. In such embodiments, the communication module 740 may comprise one or more modules, such as program modules 42 described with respect to FIG. 1, and may be configured to collect and send (periodically or in real-time) usage behavior and pattern data to the server 704.

The server 704, one or more data sources 706, and one or more client devices 710 may include additional or fewer modules than those shown in FIG. 4. In embodiments, separate modules may be integrated into a single module. Additionally, or alternatively, a single module of FIG. 7 may be implemented as multiple modules. Moreover, the quantity of devices and/or networks in the environment 700 is not limited to what is shown in FIG. 7. In practice, the environment 700 may include additional devices and/or networks; fewer devices and/or networks; different devices and/or networks; or differently arranged devices and/or networks than illustrated in FIG. 7.

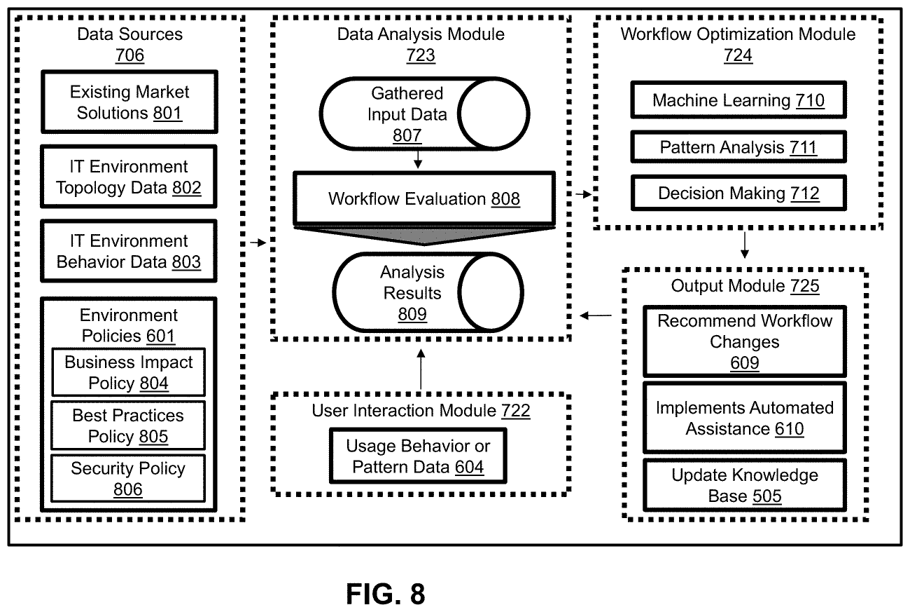

FIG. 8 is a diagram illustrating system components in accordance with embodiments of the invention. The example of FIG. 8 may be implemented in the environment of FIG. 7 and is described with reference to elements depicted in FIG. 7. Data sources 706 depicted in FIG. 8 include sources for existing market solutions 801, sources of IT environment topology data 802, sources of IT environment behavior data 803, and sources for environment policies 601. As illustrated, environment policies 601 may include, for example, business impact policies 804 (e.g., information regarding policies or rules having an impact on business); best practices policies 805 (e.g., policies regarding best practices for a particular industry or process); and security policies 806 (e.g., user or third party access rules or policies).

With continued reference to FIG. 8, the data analysis module 723 obtains gathered input data 807 (e.g., input data gathered by the data collection module 720), and performs a workflow evaluation 808 to analyze one or more workflows and analysis results of the workflow evaluation 809. In embodiments, the user interaction module 722 provides usage behavior or pattern data 604 to the data analysis module 723, as part of the gathered input data 807. In embodiments, the usage behavior or pattern data 604 includes data regarding user interaction with the environment through commands executed, and resulting logs. In embodiments, usage behavior or pattern data 604 comprises system data (e.g., execution logs) that is interpreted by the server 704 to identify user interactions, such that the risk of exposing or engaging directly with personal information of a user is minimal. In implementations, the data analysis module 723 sends data to the workflow optimization module 724 for further analysis.

In embodiments, the workflow optimization module 724 utilizing machine learning 710, pattern analysis 711, and decision making 712 to generate results, which may be sent to an output module 726. In implementations, the output module 726 obtains results from the workflow optimization module 724 and, based thereon: recommends workflow changes at 609; implements automated assistance at 610 to automatically implement one or more actions based on the results; and updates the knowledge base (e.g., knowledge base store 727) at 505.

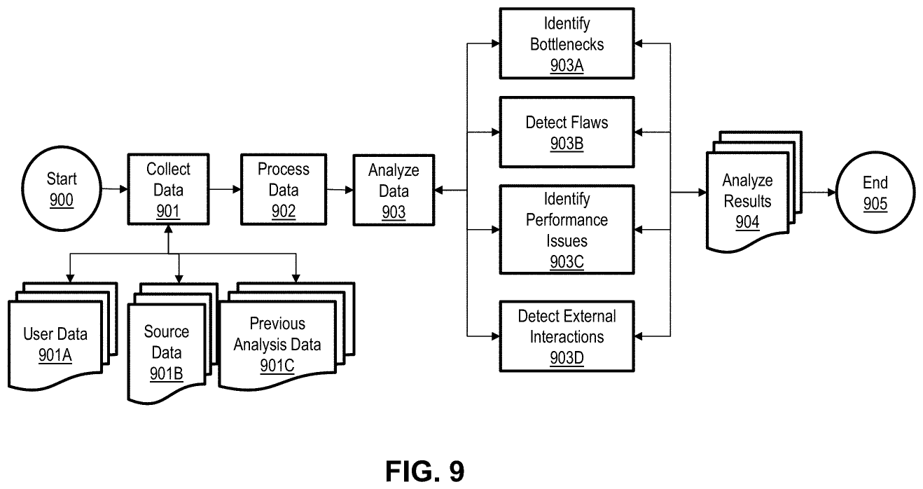

FIG. 9 is a flowchart of an exemplary workflow evaluation method in accordance with embodiments of the invention. Steps of the method may be carried out in the environment of FIG. 7 and are described with reference to elements depicted in FIG. 7.

At 900, the server 704 initiates the workflow evaluation method automatically or based on manual input by a user (e.g., via a user interface such as I/O interface(s) 22 depicted in FIG. 1). In embodiments, the data analysis module 723 of FIG. 7 implements step 900.

At step 901, the server 704 collects input data 901 from one or more data sources (e.g., (e.g., data sources 706, client devices 710). Input data may include user data 901A (e.g., usage behavior or pattern data 604 of FIG. 6), source data 901B (e.g., environment policies data 601, environment topology data 602, environment behavior data 605, and business impact data 606); and previous analysis data 901C (e.g., data from the data store 721 or the knowledge base store 727). In embodiments, the data collection module 720 of FIG. 7 implements step 901.

At step 902, the server 704 processes the data in preparation for analysis. Data processing may include filtering or cleaning data, transforming data, or otherwise preparing data for analysis. It should be understood that data processing steps are not intended to be limited to those discussed herein. Data processing 902 may include In embodiments, the data analysis module 723 of FIG. 7 implements step 902.

At step 903, the server 704 analyzes/inspects the data obtained at step 901 to generate results, including actual or potential problems (e.g., errors, inefficiencies, vulnerabilities) in existing workflows implemented in an environment. In embodiments, the data analysis module 723 and/or the workflow optimization module 724 of FIG. 7 implements step 903. In the example of FIG. 9, analyzing the data includes: identifying bottlenecks in workflows at substep 903A, detecting flaws in workflows at substep 903B, identifying performance issues at substep 903C, and detecting external interactions of the workflow (e.g., third party access/interactions) at substep 903D.

At step 904, the server 704 analyzes the results from step 903 to determine actions to take. In embodiments, the workflow optimization module 724 implements step 904.

At step 905 the server 704 ends the workflow evaluation method. In implementations, the server 704 ends the workflow evaluation method after implementing one or more automatic actions in response to the analyzed results at step 904.

In implementations, the server 704 is configured to detect patterns in historically executed workflows as candidates for use in decisions affecting workflow capabilities (e.g., solutions to detected problems). In embodiments, detecting patterns includes: identifying a type of workflow by extracting key words from a workflow name, summary and description; identifying workflow objects (i.e., steps or processes) and associated dependencies; extracting from the workflow objects a type, execution performance average, complexity, order (e.g., of steps) and a match reference with topology objects; adding a first evaluation of a business impact of the workflow; identifying key workflow steps according to associated priority rating; correlating the workflow objects with market workflows containing similar objects; and evaluating ranked workflows to determine which workflows meet needs of a company using information including business infrastructure, business policies and existing workflows in a knowledge base.

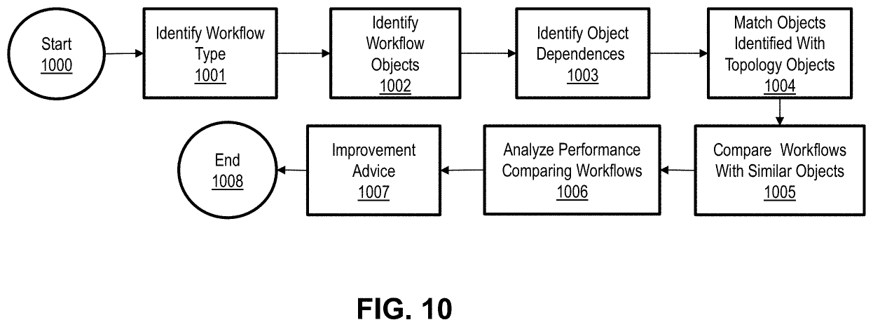

FIG. 10 is a flowchart illustrating steps of a workflow evaluation method in accordance with embodiments of the invention. Steps of the method may be carried out in the environment of FIG. 7 and are described with reference to elements depicted in FIG. 7.

At step 1000, the server 704 initiates a method for extracting information from a workflow being analyzed. In embodiments, step 1000 is part of the data analysis step 903 of FIG. 9, and is implemented by the data analysis module 723 of FIG. 7.

At step 1001, the server 704 identifies a workflow type or category associated with the workflow being analyzed. In embodiments, the server 704 utilizes natural language processing (NLP), pattern recognition tools, and/or predetermined rules to determine a type or category of workflow (e.g., service request management process, incident management, change management, access management event remediation, IT inventory and topology). In implementations, the server 704 extracts key words from the workflow name, summary and description, and utilizes natural language processing to match the keywords to predetermined categories or types based on stored rules. In embodiments, the data analysis module 723 of FIG. 7 implements step 1001.

At step 1002, the server 704 identifies workflow objects (e.g., individual steps or processes of the workflow) utilizing NLP, pattern recognition tools, and/or predetermined rules, for example. In embodiments, the server 704 extracts steps of a workflow; type of steps of the workflow (e.g., rest message, loop, decision, etc.); and determines an execution performance average, complexity, and order of steps. In embodiments, the data analysis module 723 of FIG. 7 implements step 1002.

At step 1003, the server 704 identifies object dependencies. The term object dependencies as used herein refers to individual steps or processes that are reliant on one or more other individual steps or processes (e.g., a step that relies on or refers to the data of another step or process). Various methods for determining object dependencies may be utilized, such as SQL management tools, etc. In embodiments, the data analysis module 723 of FIG. 7 implements step 1003.

At step 1004, the server 704 matches identified objects with topology objects of the environment at issue. In implementations, the server 704 matches objects (e.g., steps) of a workflow to topology objects based on the type of object and/or predetermined rules indicating which object types are associated with which topology objects. In embodiments, the data analysis module 723 of FIG. 7 implements step 1004. In implementations, steps 1002-1004 provide a first evaluation of the business impact of a workflow, and identify key workflow steps with higher relative priority

At step 1005, the server 704 compares available market solutions (e.g., workflow templates for processes or steps) and/or solutions in the knowledge base store 727 with similar objects (steps or processes) in the workflow under analysis to identify one or more solutions or workflows that match the workflow under analysis. In implementations, the server 704 correlates the workflow steps or processes (i.e., objects) identified at step 1002 with existing market workflows that contain similar steps or processes (objects) and/or solutions (e.g., workflows) in the knowledge base store 727. In embodiments, the server 704 utilizes characteristics of the workflow and/or workflow steps to correlate the workflow at issue with one or more solutions. Characteristics may include, workflow name; object dependencies; type, execution performance average, complexity, order, priority rating, and/or match reference with topology objects for each object (e.g., step) of the workflow. In embodiments, the data analysis module 723 and/or the workflow optimization module 724 of FIG. 7 implement step 1005.

At step 1006, the server 704 determines the performance of the workflow under analysis and the performance of the one or more matching market workflows, and compares the performance to determine the workflow with the best performance. In implementations, the determined performances are in the form of scores (e.g., based on weighted performance parameters), and the server 704 ranks the scores of the performances to determine the workflow with the highest rank or score. In embodiments, the performance of workflows is based on one or more of the following performance parameters: a company's needs based on its infrastructure, business policies of the company, existing workflow in the knowledge base that match the workflow under analysis (e.g., are similar based on an analysis of the type and content of the workflows). In aspects of the invention, the server 704 maps performance to workflow steps or processes. In embodiments, the data analysis module 723 and/or the workflow optimization module 724 of FIG. 7 implement step 1006.

At step 1007, the server 704 generates one or more suggestions (improvement advice) to improve the workflow under analysis based on the comparison of performances at step 1006. In implementations, the one or more suggestions include a mapping of the performance and workflow steps or processes, and identifying the workflow steps or processes that may be improved based on the analysis of step 1006. In aspects of the invention, the suggestions are based on improving security, topology, and/or the overall complexity of the workflow under analysis. In embodiments, the workflow optimization module 724 and/or the output module 726 of FIG. 7 implement step 1007.

At step 1008, the server 704 ends the workflow evaluation method. In implementations, the server 704 ends the workflow evaluation method after implementing one or more automatic actions in response to the improvement advice generated at step 1007.

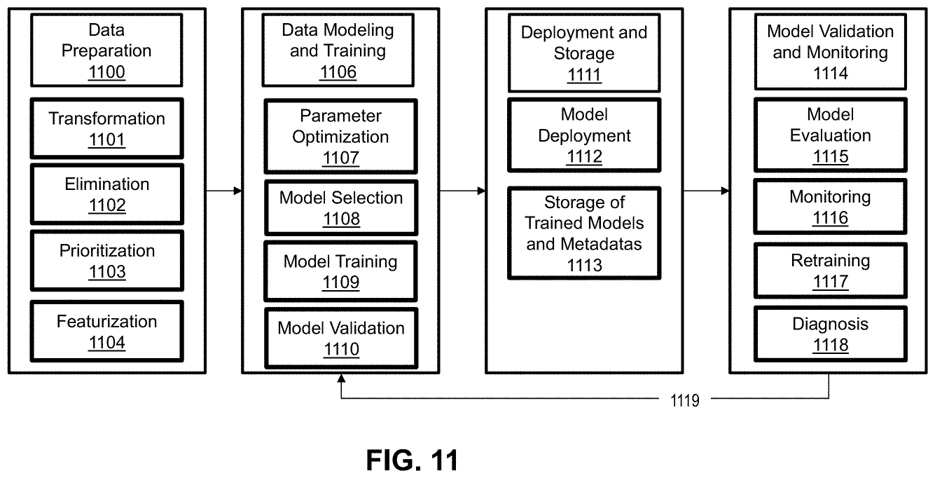

FIG. 11 is a diagram illustrating a machine learning pipeline in accordance with embodiments of the invention. Steps indicated in FIG. 11 may be carried out in the environment of FIG. 7 and are described with reference to elements depicted in FIG. 7. In embodiments of the invention, the work optimization module 724 utilizes AI techniques and tools to perform data analysis on data inputs. As depicted in FIG. 8, the AI techniques and tools utilized by the workflow optimization module 724 of the server 704 may include machine learning 710, pattern analysis 711, and decision making 712.

With reference to FIG. 11, at 1100, the server 704 performs a data preparation process to prepare data inputs (e.g., data inputs 600 of FIG. 6) for use in data modeling and training. It can be understood that the quality of data used as input for modeling and training can affect the whole model. In the example shown, the data preparation process 1100 includes data transformation 1101, data elimination 1102, prioritization of data 1103, and featurization 1104. In general, transformation refers to the process of converting data from one format or structure into another format or structure. The term data elimination as used herein refers to the removal of non-relevant data (e.g. data filtering) to reduce the amount of data to analyze. In general, prioritization of data refers to a ranking or sorting of data according to prioritization rules indicating how useful or important the data is. The term featurization as used herein refers to a way of changing some form of data into a numeric vector for use in machine learning. Various data processing techniques and tools may be utilized by the server 704, and the present invention is not intended to be limited by examples provided herein. In embodiments, the data analysis module 823 implements process 1100.

At 1106, the server 704 performs a data modeling and training process. In the example shown, the data modeling and training process 1106 includes parameter optimization 1107, model selection 1108, model training 1109, and model validation 1110. In general, parameter optimization refers to the selection of parameter values which are optimal in some desired sense. The term model selection as used herein refers to the task of selecting a model (e.g., AI model) from a set of candidate models, for a predictive modeling problem.

In general, model training (e.g., machine learning model training) refers to a process by which a model (in the form of a software program) is trained on a training data set using a supervised learning method, to perform specific tasks (e.g., pattern analysis and decision making). The training data set may be a set of data in the knowledge base store 727, for example. In embodiments, the model training utilizes algorithms (e.g., semi-supervised or reinforcement) to extract features from data and make predictions. In implementations, the server 704 utilizes a semi-supervised learning approach, which combines a small amount of labeled data with a large amount of unlabeled data during training. In embodiments, the server 704 utilizes reinforcement learning, which is a machine learning training method based on rewarding desired behaviors and/or punishing undesired ones.

The term model validation as used herein, refers to a process where a trained model is evaluated with a testing data set. In implementations, once the server 704 completes the model validation 1110, the model is ready to deploy. The server 704 may utilize various parameter optimization, model selection, model training, and model validation techniques, and the present invention is not intended to be limited to particular parameter optimization, model selection, model training, and model validation techniques. In embodiments, the server 704 utilizes a continuous improvement process to evaluate, monitor and retrain models if necessary based on one or more triggering events (e.g., a predetermined time period has passed, the knowledge base store 727 is updated, etc.). In embodiments, the machine learning module 727 of the server 704 implements process 1106.

At 1111, the server 704 performs a deployment and storage process. In the example show, the deployment and storage process 1111 includes model deployment 1112 and storage of trained models and meta data 1113. In implementations, the server 704 deploys a trained model generated by the process 1106 for use by the workflow optimization module 724 during workflow analysis. In embodiments, the server 704 stores a trained or updated model obtained by the process 1106 in the data store 721. In embodiments, the machine learning module 727 of the server 704 implements process 1111.

At 1114, the server 704 performs a model validation and monitoring process. In the example show, the model validation and monitoring process 1114 includes model evaluation 1115, monitoring 1116, retraining 1117, and diagnosis 1118. As indicated at 1119, models identified for retraining according to process 1114 may be updated according to the data modeling and training process 1106. Retraining 1117 of models may occur iteratively, as new training data becomes available (e.g., upon updates to the knowledge base store 727.) Models may be utilized by the server 704 for diagnosis 1118 (e.g., identify patterns are make decisions). In embodiments, the machine learning module 727 of the server 704 implements process 1114.

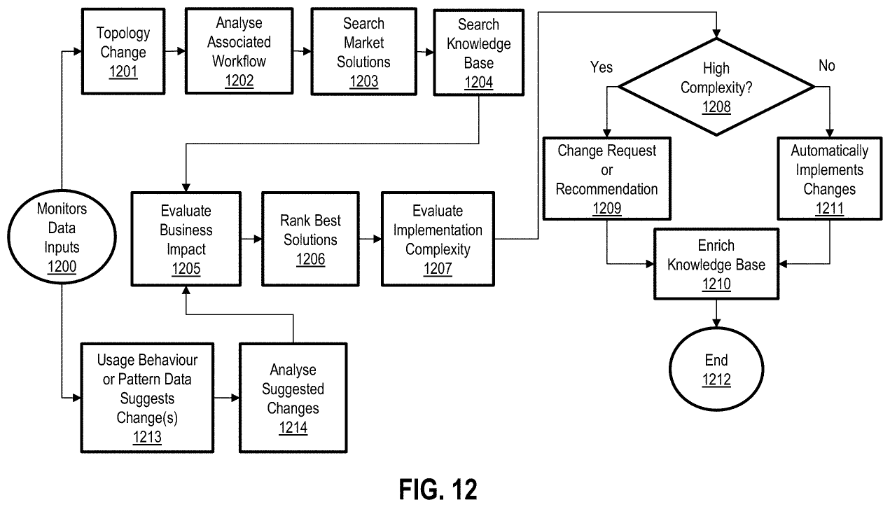

FIG. 12 is a flowchart illustrating an online (e.g., real-time) workflow method in accordance with embodiments of the invention. Steps of the method may be carried out in the environment of FIG. 7 and are described with reference to elements depicted in FIG. 7.

At step 1200, the server 704 monitors data inputs (e.g., 600 of FIG. 6) for a triggering event (e.g., topology changes, patterns of user behavior) indicating that a workflow analysis should be conducted. In implementations, the server 704 monitors environment topology data (e.g., 602 of FIG. 6) for a particular environment (e.g., a business customer) to determine if there is a change in topology within the environment, such as a change in hardware, a change in software, or a change in another resource. In embodiments, the server 704 monitors usage behavior or pattern data for data suggesting changes to a workflow. In one example, users of a workflow deviate from an automated procedure 70% of the time, indicating that there may be a change needed to the workflow.

In implementations, the server 704 monitors real-time data inputs from data sources 706 at step 1200. In embodiments, the server 704 performs real-time analysis of data inputs, and acts as an active observer, with access to all existing policies for best practices, business impact, and security. In aspects of the invention, the server 704 continuously gathers and consults data sources for an environment at issue, including data regarding the IT environment's behavior, topology and user interaction, as well as output data from past analysis, previous workflow updates and the existing knowledge base (e.g., knowledge base store 727).

At step 1201 the server 704 identifies a change to the topology (e.g., physical topology or network topology) of an environment at issue based on the monitoring at 1200, as a triggering event. In embodiments, the data analysis module 723 implements step 1201.

At step 1202, the server 704 identifies and analyses one or more workflows based on the change in the topology. In implementations, the server 704 identifies and analyzes one or more workflows executed in the environment at issue which are associated with or impacted by the identified change to the topology, to determine possible problems (e.g., errors or inefficiencies) to address. In implementations, the step 1202 utilizes method steps of FIGS. 9 and 10 to analyze the one or more workflows. In embodiments, the data analysis module 723 and/or the workflow optimization module 724 implement step 1202. In implementations, the workflow optimization module 724 utilizes the machine learning module 725 to: identify a type of workflow by extracting key words from the workflow name, summary and description; identify workflow steps (objects) and associated dependencies; extract from the workflow step a type, execution performance average, complexity, order of steps and a match reference with topology objects; and identifies key workflow steps according to associated priority ratings of the workflow steps.

At step 1203, the server 704 searches marked solutions to identify any market workflows that match the one or more workflows identified at step 1202, and determines possible solutions based on the market workflows that match. In one example, when the server 704 determines that a new service is associated on an IT environment at issue (e.g., a new monitoring tool has been installed), the server 704 looks for available templates (market solutions) that could be used to make the workflow for the new service (e.g., workflow for monitoring tool integration) and also considers previous integrations, business and environment particularities at step 1204 in order to recommend the best workflow based on the company needs. The server 704 may utilize steps of FIG. 10 to implement step 1203. In embodiments, the data analysis module 723 and/or the workflow optimization module 724 implement step 1203. In embodiments, the workflow optimization module 724 utilizes the machine learning module 725 to correlate the workflow objects (e.g., steps) with market workflows containing similar (e.g., matching based on rules) objects (e.g., steps).

At step 1204, the server 704 searches the knowledge base (e.g., knowledge base store 727) to determine any steps, processes or workflows in the knowledge base that match the one or more workflows at issue identified at step 1202, and determines possible solutions based on the steps, processes or workflows that match. For example, the knowledge base may house a workflow solution to a problem identified at step 1202. The server 704 may utilize steps of FIG. 10 to implement step 1204. In embodiments, the workflow optimization module 724 implements step 1204. In implementations, the workflow optimization module 724 utilizes the machine learning module 725 to correlate the workflow objects (e.g., steps) with workflows in the knowledge base containing similar (e.g., matching based on rules) objects (e.g., steps).

At step 1205, the server 704 evaluates the business impact of possible solutions (e.g., suggested changes to the workflow) determined based on business parameters determined from existing rules and business data for the environment at issue (e.g., company). In embodiments, the server 704 assigns a rating or score (e.g., low, medium and high impact) to each of the possible solutions indicating an impact of the solution on the business/environment based on environment information (e.g., environment policies 601, environment topology 602, environment behavior 605). For example, implementing one possible solution may require additions to the topography that would impact the business (e.g., monetary cost and time to implement cost). In embodiments, the workflow optimization module 724 implements step 1204 by ranking possible solutions (workflow solutions) based on one or more of the performance parameters of a company/environment at issue derived from the environment information.

At step 1206, the server 704 scores and ranks performances of the possible solutions using, for example, steps of FIG. 10. In implementations, the server 704 ranks and scores possible solutions to determine one or more of the highest ranking or scoring possible solutions according to predetermined rules (e.g., top 2 solutions). In embodiments, the server 704 determines one or more solutions to implement based on the ranking of the possible solutions. In embodiments, the workflow optimization module 724 implements step 1206. It should be understood that solutions may include: adding one or more steps to a workflow at issue; inactivating or removing one or more steps from the workflow at issue; replacing one or more steps of the workflow at issue with one or more other steps (e.g., from a market solutions or solution in the knowledge base store 727); inactivate or remove the workflow at issue; or replacing the workflow at issue with one or more other workflows (e.g., from a market solutions or solution in the knowledge base store 727).

At step 1207, the server 704 evaluates implementation complexity for one or more possible solutions or the determined solutions to implement (e.g., a highest ranked possible solution). The term implementation complexity as used herein refers to how complex implementing a solution is based on predetermined rules. In implementations, complexity is determined based on weighted complexity parameters, and indicates whether the solution can be implemented automatically, or whether the solution requires manual input of a user or administrator. In embodiments, the data analysis module 723 and/or the workflow optimization module 724 implement step 1206.

In embodiments, once the server 704 finds a best solution to a problem or inefficiency, the server determines whether the solution can be automatically implemented/applied, or whether the solution requires human intervention to implement/apply the solution.

At step 1208, the server 704 determines whether the one or more possible solutions can be automatically implemented, or requires additional assistance (e.g., manual assistance) to be implemented, based on the implementations complexity determined at step 1207. In embodiments, the workflow optimization module 724 and/or the output module 726 implements step 1208.

At step 1209, when the server 704 determines at step 1208 that the one or more possible solutions cannot be implemented automatically by the server 704 (i.e., the solution has a high complexity) the server 704 sends out a change request or recommendation. The change request or recommendation may be a request to another computing module or computing device requesting automated assistance to implement one or more solutions, or may be a request for manual assistance (e.g., to an administrator/user) or a recommendation to implement one or more solutions. The change request or recommendation can included a description or instructions for the assistance needed to implement one or more solutions. In embodiments, step 1209 also includes the server 704 receiving a notification (e.g., a notification that a change was or was not implemented or a receipt acknowledgement) from the other computing module, computing device or administrator/user. In embodiments, the output module 726 implements step 1209.

At step 1210, the server 704 updates or enriches the knowledge base (e.g., knowledge base store 727) based on the implementation of changes at 1211, the change request or recommendation at 1209, or a notification (confirmation or acknowledgment) received in response to the change request or recommendation. For example, the knowledge base store 727 may be updated to include the changes to workflow, or a new workflow, or a reason why a solution was not implemented. By including the workflow analysis findings of the server 704 in the knowledge base, an updated knowledge base is generated which may be utilized in future workflow analyses, ensuring continuous learning of the server 704. In embodiments, the output module 726 implements step 1210.

At step 1211, when the server 704 determines at step 1208 that the one or more solutions can be implemented automatically by the server 704 (i.e., the solution does not have a high complexity) the server 704 automatically implements one or more changes (e.g., updating a workflow or implementing a new workflow) based on the one or more possible solutions. In embodiments, the output module 726 implements step 1211.

At step 1212, the server 704 ends the online (real-time) workflow method in response to the output module 726 completing a task associated with the one or more possible solutions (e.g., automatically implementing workflow changes, or receiving an acknowledgement in response to a change request or recommendation). In embodiments, the output module 726 implements step 1212.

With continued reference to FIG. 12, at step 1213, the server 704 identifies usage behavior or patterns that suggests one or more changes to a workflow. For example, when usage data from users indicates that 70% of the users modify a particular step of a workflow, the server 704 may identify that a change to the workflow is suggested. In embodiments, the data analysis module 723 implements step 1213.

At step 1214, the server 704 analyzes the suggested one or more changes to the workflow (possible solutions) determined at step 1213 to generate information regarding the one or more changes for use in determine impacts of the changes. In embodiments the server 704 can utilize steps of FIG. 10 to implement step 1214. For example, in implementations the server 704 determine objects of the workflow and determines matching topology objects. The server 704 then sends information generated at step 1214, and the server 704 proceeds to perform steps 1205-1212 as described above.

In implementations, the above-described online (real-time) workflow method generates recommended changes to a company's workflow(s) and initiates implementation of the workflow changes (directly or indirectly) based on the IT environment infrastructure behavior and detection of patterns and bottlenecks of workflows being executed. Thus, embodiments of the invention provide IT workflow structure that best aligns with the company's business strategy. Implementations of the method also take into consideration the existing best practices for basic workflows, such as: approval request management incident management, event management and remediation, group management, etc. In embodiments, the server 704 aligns known or learned best practices with a company's business standards data, so that the server 704 can be more assertive regarding recommendations for workflow changes.

In embodiments, all data inputs collected and stored by the server 704 are used in real-time by the data analysis module 723 and the workflow optimization module 724. In aspects of the invention, the data analysis module 723 processes the data inputs to optimize the data and identify trends, flaws, bottlenecks and performance, and the workflow optimization module 724 learns from the data in order to predict workflow behaviors, determine solutions and ways to implement and document the solutions, and generate one or more possible workflow changes (solutions) that are ranked based on parameters such as complexity, risk and efficiency.

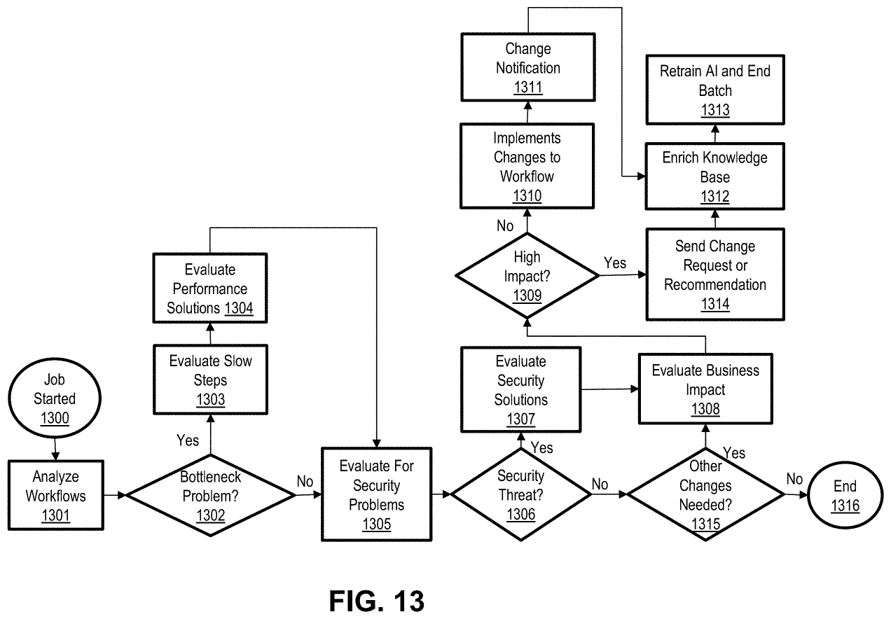

FIG. 13 is a flowchart illustrating an offline workflow method in accordance with embodiments of the invention. Steps of the method may be carried out in the environment of FIG. 7 and are described with reference to elements depicted in FIG. 7.

At step 1300, the server 704 starts an offline workflow analysis job. The job may be a batch analysis job wherein a batch of workflows is analyzed, or may be analysis of a single workflow. The offline workflow method may be triggered according to a predetermined schedule, or may be triggered manually. In embodiments, the offline workflow method may be utilized in conjunction with the online workflow method of FIG. 12. In embodiments, the offline workflow method of FIG. 13 is implemented when the cost of analyzing real-time input data is too high. In embodiments, the data analysis module 723 implements step 1300.

At step 1301, the server 704 analyzes one or more workflows to identify errors or inefficiencies (problems). In embodiments, the server 704 compares data inputs with data collected from multiple data sources in the knowledge base store 727, utilizing machine learning models of the server 704 to identified problems in the workflows being analyzed. In implementations, the server 704 identifies bottlenecks, security threats, changes indicated by usage data or other problems, and identifies which steps of the workflows are creating the problems. In aspects of the invention, the server 704 utilizes machine learning models to search for patterns and/or solutions, and evaluates if there is a solution available for a specific identified problem, or multiple problems. The server 704 may implement 1301 using the methods described with respect to FIGS. 9 and 10 above. In embodiments, the data analysis module 723 and/or the workflow optimization module 724 implement step 1301.

At step 1302, the server 704 determines if any bottlenecks were identified at step 1301, and if one or more bottlenecks were identified, the server 704 advances to step 1303. Conversely, if no bottlenecks were identified at step 1301, the server 704 advances to step 1305. In embodiments, the data analysis module 723 and/or the workflow optimization module 724 implement step 1302.

At step 1303, the server 704, when the server 704 identifies one or more bottlenecks in one or more workflows at 1301, the server evaluates steps of the workflows at issue (workflows with bottlenecks) to determine possible solutions to one or more bottleneck problems. In implementations, when the server 704 detects a bottleneck, the server 704 checks the workflow steps that are mostly like to take time to complete and it tries to fix this problem based on an analyses of alternatives steps that could be executed faster. One example is an approval request for a new laptop. In this example, the server 704 determines, based on data in the knowledge base store 727, that 99% of the cases where the machine status is “damaged” and the collaborator is requesting the same machine type, the request has been approved. In this case, the server 704 may send an email to a user/manager asking permission to update the workflow to approve the request in these cases in accordance with step 1314, thereby removing this bottleneck. The server 704 may implement step 1303 using the methods described with respect to FIGS. 9 and 10 above. In embodiments, the data analysis module 723 and/or the workflow optimization module 724 implement step 1303.

At step 1304, the server 704 evaluates the performance of each the possible solutions to the one or more bottleneck problems identified at step 1303, to determine which of the one or more solutions to implement. In implementations, each of the possible solutions are rated or scored to indicate a level of business impact the respective possible solution would have if implemented (e.g., high impact, low impact). The server 704 may implement 1304 using the methods described with respect to FIGS. 9 and 10 above. In embodiments, the data analysis module 723 and/or the workflow optimization module 724 implement step 1304.

At step 1305, the server 704 evaluates the workflows for security issues. In embodiments, the server 704 analyzes workflows based on security policies to determine whether the workflows are compliant with applicable security policies, and if any security threats exist. In implementations, the server 704 utilizes synthetic monitoring techniques to identify security problems or vulnerabilities. The term synthetic monitoring as used herein refers to a method of monitoring software programs by simulating an action or path that a user would take on a site, application or other software. The server 704 may implement 1305 using the methods described with respect to FIGS. 9 and 10 above. In embodiments, the data analysis module 723 and/or the workflow optimization module 724 implement step 1305.

At step 1306, the server 704 determines if any security threats were identified at step 1305, and if one or more security threats were identified, the server 704 advances to step 1306. Conversely, if no security threats were identified at step 1305, the server 704 advances to step 1315. In embodiments, the data analysis module 723 and/or the workflow optimization module 724 implement step 1306.

At step 1307, when the server 704 identifies one or more security threats in one or more workflows at 1305, the server 704 evaluates steps of the workflows at issue (workflows with security threats) to determine possible solutions to one or more security threat problems. The server 704 may implement 1307 using the methods described with respect to FIGS. 9 and 10 above. In embodiments, the data analysis module 723 and/or the workflow optimization module 724 implement step 1307.

At step 1308, the server 704 evaluates the performance of each of the possible solutions to the one or more security problems (e.g., non-compliance with security policies, security threats) identified at step 1305, to determine which of the one or more possible solutions to implement. In implementations, each of the possible solutions are rated or scored to indicate a level of business impact the respective possible solution would have if implemented (e.g., high impact, medium impact, low impact). In embodiments, the server 704 generates recommendations for which solution(s) should be implemented immediately based on the determined impact of the solution. The server 704 may implement 1308 using the methods described with respect to FIGS. 9 and 10 above. In embodiments, the data analysis module 723 and/or the workflow optimization module 724 implement step 1308.

At step 1309, the server 704 determines if the one or more possible solutions to implement (to address bottleneck or security problems) have a high impact (e.g., score above a threshold value), and for each possible solution that does not have a high impact (e.g., score is below the threshold value), the server 704 advances to step 1310. Conversely, for each of the possible solutions to implement having a high impact, the server 704 advances to step 1314. In implementations, if the server 704 determines that the impact of a possible solution is medium or low, the server 704 implements that changes automatically at step 1310 and notifies users or administrators of the changes at step 1311. In embodiments, the data analysis module 723 and/or the workflow optimization module 724 implement step 1309.

At step 1310, the server 704 automatically implements changes to one or more workflows based on the one or more solutions to implement determined at steps 1304, 1307 and 1309. The server 704 may implement 1310 using the methods described with respect to FIG. 12 above. In embodiments, the output module 726 implements step 1310.

At step 1311, the server 704 optionally issues a change notification to a user or administrator, indicating the changes automatically implemented at step 1310. In embodiments, the output module 726 implements step 1311.

At step 1312, the server 704 updates or enriches the knowledge base (e.g., knowledge base store 727) to reflect the changes implemented at step 1310, and or the change recommendation of step 1314. In implementations, whether or not the impact of a solution is determined to be highly impact (e.g., meets a threshold), the server 704 updates or enriches the knowledge base with the information determined during the workflow analysis. In embodiments, the output module 726 implements step 1311.

At step 1313, the server 704 updates or retrains machine learning models utilized by the server 704 based on the updated or enriched knowledge base, and ends the offline workflow method. Step 1313 may be done automatically when a change to the knowledge base is determined, or periodically (e.g., based on a schedule). In embodiments, the machine learning module 725 of the workflow optimization module 724 implements step 1313.

At step 1314, in response to determining that one or more solutions to implement has a high business impact (e.g., having a score meeting or exceeding a threshold value), the server 704 sends a change recommendation to a user or administrator (e.g., via a user interface of the server 704 and/or one or more of the client devices 710). In implementations, the change recommendation comprises a detailed report regarding one or more workflow steps causing the problem(s), and one or more recommended solutions. In aspects of the invention, if a user declines to implement a change recommended by the server 704 at step 1314, the user updates the knowledge base store 727 with a reason why the recommended solution was discarded. In implementations, the server 704 determines when a solution has already been discarded based on the reasons in the knowledge base store 727, and does not recommend the same solution for the same workflow based thereon. In embodiments, the output module 726 implements step 1314.

At step 1315, the server 704 determines if any additional problems or inefficiencies have been detected by the server 704, and potential solutions identified, and if no other problems or inefficiencies have been detected, the server 704 ends the offline workflow method at 1316. Conversely, if the server 704 detects additional problems or inefficiencies, and identifies potential solutions to those problems or inefficiencies, the business impact of the potential solutions are evaluated at 1308 as described above. In embodiment, the data analysis module 723 and/or the workflow optimization module 724 implement step 1315.

### Exemplary Use Scenarios

In the following exemplary use scenarios, a company ABCS in the financial industry utilizes a hybrid cloud computing system to manage its daily workload. More specifically, ABCS uses an IT service management (ITSM) tool to manage service requests, incident management, change management, access management, event remediation, and IT inventory and topology.

Most of the workflows used by the ITSM tool are from default templates (e.g., market solutions), and the default templates are rarely reviewed, as IT specialists of the company are usually attending to more higher priority demands, such as keeping the ITSM tool infrastructure healthy, and adding new features in a web portal to improve user experience, etc. The lack of default template review leads to the use of outdated workflows by the ITSM tool that include inefficiencies (e.g., performance problems or security vulnerabilities).

ABCS implements workflow analysis according to embodiments of the invention to obtain improved workflows. Initially, the server 704 begins collecting environment data from the hybrid cloud topology and inventory, and previous workflow executions. The server 704 further accesses market solutions data to identify existing market solutions matching the company's needs, and collects feedback to determine the business impact of various workflows (e.g., from the highest impact to lowest impact). The server 704 then recommends an approach to improve one or more workflows, thus enabling ABCS to deploy complex solutions faster.

### Example 1

In a first example, the server 704 uses workflow analysis according to embodiments of the invention to identify changes in ABCS's environment. Specifically, the ITSM tool uses a virtual private network (VPN) installed in a cloud server, in order to receive data for events from ABCS's on-premise environment. As the events grew, it was necessary to use a new server to handle the requests. In this example, the server 704 automatically observed a change on the topology of ABCS (introduction of a new server), and after evaluating the change, ranked the best solutions to address the change (e.g., impact of the change on workflows), and initiated a new step (solution) to balance which server should be used in the workflows that make use of the VPN service.

### Example 2

In a second example, the server 704 uses workflow analysis according to embodiments of the invention to identify and fix a bottleneck in a workflow of ABCS. More specifically, the server 704 scans the executions of workflows to determine if there is a performance issue in any of the workflows. The server 704 determines that a workflow created to remediate an incident using an IT automation tool was taking too long to complete, based on a comparison of the workflow with information in the knowledge base store 727. The server 704 identified the slowest step of the workflow as the step that checks if an automation tool has finished running an execution of a job to fix a problem. After analyses based on the company's environment, the knowledge base store 727, and market solutions, the server 704 determines that utilizing a webhook (webhook solution) to perform the slowest step could increase the workflow performance significantly, but also determines that implementation of the webhook solution would have a high business impact, as this approach would change a lot of steps of the workflow. In this case, the server 704 sends a notification (e.g., a request for implementation assistance) to an IT specialist with guidance to implement changes required for the webhook solution, so that the IT specialist can determine whether to implement the webhook solution or disregard the suggestion.

### Example 3

In a third example, the server 704 uses workflow analysis according to embodiments of the invention to identify and remediate security vulnerabilities. Specifically, the server 704 periodically determines whether the workflows could be exposed to security threats. In this example, the ABCS company used a default template to send notifications about incidents and changes to an instant message tool. The server 704 determines that the way to connect to the instant message was deprecated and no longer secure, ranked the best possible solutions to address the security issue, and automatically implemented the best possible solution: to inactivate the workflow and send an alert to an administrator/user to modify the way to connect to the tool.

Based on the above, it can be understood that embodiments of the invention provide the following benefits to service clients: resolve complex problems more quickly (e.g., implementing a new IT architecture workflow with the assistance of automated solution recommendations); decrease time to market new workflows; follow workflows best practices that aligned with business goals; make use of automated solutions to change workflow execution on the fly; and allow administrators to focus on more relevant activities, thereby reducing the number of IT specialist needed to support an environment.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
aggregating, by a computing device, input data from an environment from multiple data sources, thereby generated aggregated input data;
automatically identifying, by the computing device, a problem in a workflow implemented in the environment by processing and analyzing the workflow based on the aggregated input data, thereby producing processed input data;
automatically determining, by the computing device, one or more solutions to the problem in the workflow using at least one iteratively trained machine learning model to analyze the processed input data, wherein the analyzing the processed input data includes:
identifying characteristics of the workflow;
identifying one or more candidate solutions based on the characteristics;
ranking the one or more candidate solutions; and
determining the one or more solutions to the problem based on the ranking; and
automatically implementing, by the computing device, at least one of the one or more solutions to address the problem in the workflow, thereby creating an updated workflow in the environment.

2. The method of claim 1, further comprising:
determining, by the computing device, a complexity of the one or more solutions; and
determining, by the computing device, that that the at least one of the one or more solutions can be automatically implemented based on the complexity.

3. The method of claim 1, further comprising:
updating the knowledge base store based on the automatically implementing the at least one of the one or more solutions to address the problem in the workflow, thereby producing an updated knowledge base store; and
retraining, by the computing device, the iteratively trained machine learning model based on the updated knowledge base store.

4. The method of claim 1, wherein:
the identifying the one or more candidate solutions comprises correlating steps of the workflow with steps of one or more market solutions and steps of one or more solutions in a knowledge base store: and
the ranking the one or more candidate solutions is based on business parameters derived from the aggregated input data.

5. The method of claim 1, further comprising monitoring, by the computing device, the aggregated input data for a triggering event, wherein the analyzing the workflow is performed in response to identifying the triggering event.

6. The method of claim 5, wherein the triggering event comprises a change in topology of the environment or a pattern of usage behavior indicating an error in the workflow.

7. The method of claim 1, wherein the problem is a bottleneck in the workflow or a security issue in the workflow.

8. The method of claim 1, wherein the identifying the characteristics of the workflow includes:
identifying a type of the workflow by extracting key words from a name of the workflow, a summary of the workflow or a description of the workflow;
identifying steps of the workflow;
identifying dependencies of the steps of the workflow; and
for each step of the workflow, determining a type, execution performance average, complexity, order, and match reference with one or more topology objects in the environment, wherein the correlating steps of the workflow with steps of one or more market solutions and steps of one or more solutions in the knowledge base stories is based on the characteristics of the workflow.

9. The method of claim 1, wherein the computing device includes software provided as a service in a cloud environment.

10. A computer program product comprising one or more computer readable storage media having program instructions collectively stored on the one or more computer readable storage media, the program instructions executable by a computing device to:
automatically identify a problem in an IT workflow implemented in the environment by processing and analyzing the IT workflow based on input data from the environment, thereby producing processed input data, wherein the IT workflow is at least partially automated and includes a series of steps to complete an IT process;
automatically determining one or more solutions to the problem in the IT workflow using at least one iteratively trained machine learning model to analyze the processed input data, wherein the analyzing the processed input data includes;
identifying characteristics of the IT workflow, including steps of the IT workflow;
identifying one or more candidate solutions by correlating steps of the IT workflow with steps of one or more market solutions and steps of one or more solutions in a knowledge base store;
ranking the one or more candidate solutions based on business parameters derived from the aggregated input data; and
determining the one or more solutions to the problem based on the ranking; and
determining whether to automatically implement at least one of the one or more solutions to address the problem in the IT workflow or send a notification to a user regarding the at least one of the one or more solutions based on a complexity of the at least one of the one or more solutions.

11. The computer program product of claim 10, wherein the program instructions are further executable by the computing device to:
automatically implement the at least one of the one or more solutions to address the problem in the workflow in response to determining that the at least one of the one or more solutions can be automatically implemented based on the complexity, thereby creating a new workflow or an updated workflow in the environment; and
automatically send a notification to a user regarding the at least one of the one or more solutions to address the problem in the workflow in response to determining that the at least one of the one or more solutions cannot be automatically implemented based on the complexity.

12. The computer program product of claim 11, wherein the program instructions are further executable by the computing device to update the knowledge base store based on the automatically implement the at least one of the one or more solutions to address the problem in the workflow, thereby producing an updated knowledge base store.

13. The computer program product of claim 12, wherein the program instructions are further executable by the computing device to retrain the iteratively trained machine learning model based on the updated knowledge base store.

14. The computer program product of claim 10, wherein the program instructions are further executable by the computing device to monitor the aggregated input data for a triggering event, wherein the analyzing the workflow is performed in response to identifying the triggering event.

15. The computer program product of claim 14, wherein the triggering event comprises a change in topology of the environment or a pattern of usage behavior indicating an error in the workflow.

16. The computer program product of claim 10, wherein the identifying the characteristics of the workflow includes:
identifying a type of the workflow by extracting key words from a name of the workflow, a summary of the workflow or a description of the workflow;
identifying dependencies of the steps of the workflow; and
for each step of the workflow, determining a type, execution performance average, complexity, order, and match reference with one or more topology objects in the environment, wherein the correlating steps of the workflow with steps of one or more market solutions and steps of one or more solutions in the knowledge base stories is based on the characteristics of the workflow.

17. A system comprising:
a processor, a computer readable memory, one or more computer readable storage media, and program instructions collectively stored on the one or more computer readable storage media, the program instructions executable to:
automatically identify a problem in an IT workflow implemented in the environment by processing and analyzing the IT workflow based on input data from the environment, thereby producing processed input data, wherein the IT workflow is at least partially automated and includes a series of steps to complete an IT process;
automatically determining one or more solutions to the problem in the IT workflow using at least one iteratively trained machine learning model to analyze the processed input data, wherein the analyzing the processed input data includes;
identifying characteristics of the IT workflow, including steps of the IT workflow;
identifying one or more candidate solutions by correlating steps of the IT workflow with steps of one or more market solutions and steps of one or more solutions in a knowledge base store, wherein the knowledge base store includes previously implemented IT workflows of the environment;
ranking the one or more candidate solutions based on business parameters derived from the aggregated input data; and
determining the one or more solutions to the problem based on the ranking; and
determining whether to automatically implement at least one of the one or more solutions to address the problem in the IT workflow or send a notification to a user regarding the at least one of the one or more solutions based on a complexity or impact of the at least one of the one or more solutions.

18. The system of claim 17, wherein the program instructions are further executable by the computing device to:
automatically implement the at least one of the one or more solutions to address the problem in the workflow in response to determining that the at least one of the one or more solutions can be automatically implemented based on the complexity or impact; and
automatically sending a notification to a user regarding the at least one of the one or more solutions to address the problem in the workflow in response to determining that the at least one of the one or more solutions cannot be automatically implemented based on the complexity or impact.

19. The system of claim 17, wherein the program instructions are further executable by the computing device to:
update the knowledge base store based on the automatically implementing the at least one of the one or more solutions to address the problem in the workflow, thereby producing an updated knowledge base store; and
retrain the iteratively trained machine learning model based on the updated knowledge base store.

20. The system of claim 17, wherein the program instructions are further executable by the computing device to monitor the aggregated input data for a triggering event, wherein the triggering event comprises a change in topology of the environment or a pattern of usage behavior indicating an error in the workflow, and wherein the analyzing the workflow is performed in response to identifying the triggering event.
